(19) United States
(12) Patent Application Publication
(10) Pub. No.: US 2013/0300961 A1
(43) Pub. Date: Nov. 14, 2013

(54) DISPLAY DEVICE

(71) Applicant: SEIKO EPSON CORPORATION, Tokyo (JP)

(72) Inventor: Naoki TOMIKAWA, Fujimi-machi (JP)

(73) Assignee: Seiko Epson Corporation, Tokyo (JP)

(21) Appl. No.: 13/889,425

(22) Filed: May 8, 2013

(30) Foreign Application Priority Data
May 10, 2012 (JP) 2012-108229

(51) Int. Cl. G02F 1/133

(52) U.S. Cl. CPC G02F 1/13306
USPC 349/33

(57) ABSTRACT

Provided is a liquid crystal panel including a liquid crystal layer interposed between a first substrate and a second substrate, and a peripheral electrode arranged so as to surround a pixel region; a lamp irradiating a liquid crystal layer with light; and a fan increasing the temperature of the liquid crystal panel during an off sequence higher than the temperature of the liquid crystal panel before a falling period.

### BACKGROUND

1. Technical Field

The present invention relates to a display device.

2. Related Art

As an electro-optical device configuring the display device, for example, an active driving type liquid crystal panel in which a transistor is provided as an element controlling switching of pixel electrodes for each pixel is known. The liquid crystal panel, for example, may be used in a direct viewing-type display, a light valve or the like.

The liquid crystal panel is configured by interposing a liquid crystal layer between a pair of substrates bonded via a seal material. It is known that display characteristics deteriorate caused by impurities (ionic impurities, or the like) included in the liquid crystal of the liquid crystal layer, or impurities introduced with the liquid crystal, or impurities eluting due to contact of the uncured or cured seal material with the liquid crystal. In addition, in a case where the liquid crystal panel is used in a light valve, it is known that there are cases where impurities are generated by deterioration of the liquid crystal due to contact of light with the liquid crystal.

For example, a method is known in which an ion trap electrode is provided, and diffusion of impurities to the display regions is suppressed, as disclosed in JP-A-2007-316119 and JP-A-2008-89938. In addition, by continuing to apply a voltage to the ion trap electrode after the power source is turned off, it is possible to suppress aggregation of the impurities in the display regions after the power source is turned off.

However, after the light source is turned off (during an off sequence), the lamp and liquid crystal panel are cooled; however, the liquid crystal panel cools first due to being smaller. Thus, there is a problem where the efficiency of an ion trap (causing impurities to be swept up) lowers (in other words, return to the display region) by the mobility of impurities lowering. In addition, there is a problem that the display characteristics due to impurities deteriorates when the power source is next turned on.

### SUMMARY

The invention can be realized in the following forms or application examples.

### Application Example 1

According to Application Example 1, there is provided a display device that includes a liquid crystal panel including a liquid crystal layer interposed between a first substrate and a second substrate arranged opposed to the first substrate via a seal material, and a peripheral electrode arranged so as to surround a display region of at least one of the first substrate and the second substrate; a light source irradiating a liquid crystal layer with light; and a cooling unit lowering the cooling ability of the liquid crystal panel during an off sequence period lower than a display period.

In this case, since the cooling ability of the liquid crystal panel in the off sequence period is lower than the display period due to the cooling unit, in other words, by weakening the cooling ability the liquid crystal panel is subjected to, rapid lowering of the mobility in the surface of ionic impurities included in the liquid crystal layer configuring the liquid crystal panel may be suppressed. Thus, it is possible to increase the effects collecting ionic impurities in the off sequence period by applying a voltage to the peripheral electrode.

### Application Example 2

In the display device according to Application Example 1, it is preferable that a liquid crystal panel including a liquid crystal layer interposed between a first substrate and a second substrate arranged opposed to the first substrate via a seal material, and a peripheral electrode arranged so as to surround a display region of at least one of the first substrate and the second substrate; a light source irradiating a liquid crystal layer with light, and a heating unit increasing the temperature of the liquid crystal panel in an off sequence period higher than the temperature of the liquid crystal panel after the off sequence period be provided.

In this case, since the temperature is increased higher than the temperature of the liquid crystal panel in the off sequence period due to the heating unit, in other words, since the temperature of the liquid crystal panel does not rapidly cool, rapid lowering of the mobility in the surface of ionic impurities included in the liquid crystal layer configuring the liquid crystal panel may be suppressed. Thus, it is possible to increase the effects collecting ionic impurities in the off sequence period by applying a voltage to the peripheral electrode.

### Application Example 3

In the display device of Application Example 2, it is preferable that the heating unit heat the liquid crystal panel so as to be a predetermined temperature during a heating period of the liquid crystal panel.

In the case, since the liquid crystal panel is maintained in the vicinity of a predetermined temperature by the heating unit, rapid lowering of the mobility in the surface of ionic impurities included in the liquid crystal layer may be suppressed. Thus, it is possible to increase the effects collecting ionic impurities during the off sequence by applying a voltage to the peripheral electrode.

### Application Example 4

In the display device of Application Example 1, it is preferable that at least one of either the cooling unit or the heating unit be adjusted such that the temperature of the liquid crystal panel becomes a predetermined temperature in a period until the temperature of the light source is cooled to a predetermined temperature.

In this case, since it is possible to suppress rapid lowering of the temperature of the liquid crystal panel, until the temperature of the light source is cooled to a predetermined temperature, by adjusting at least one of either the cooling unit and heating unit, it is possible to suppress rapid lowering of the mobility in the surface of ionic impurities. As a result, it is possible to increase the effects collecting ionic impurities during the off sequence.

### Application Example 5

In the display device of Application Example 4, it is preferable that a voltage be applied to the peripheral electrode at least from a start of the off sequence period until the temperature of the liquid crystal panel becomes a predetermined temperature.

In this case, since a voltage is applied to the peripheral electrode during a temperature at which at least the ionic impurities in the surface are mobile, it is possible to increase the effects collecting ionic impurities.

### Application Example 6

In the display device of Application Example 1, it is preferable that a measurement unit measuring the temperature of the liquid crystal panel be provided, and the measurement unit use a thermocouple.

In this case, since the temperature of the liquid crystal panel is measured using a thermocouple, it is possible to effectively adjust the temperature of the liquid crystal panel using a cooling unit or heating unit.

### BRIEF DESCRIPTION OF THE DRAWINGS

The present invention will be described with reference to the accompanying drawings, wherein like numbers reference like elements.

FIG. 1 is a schematic plan diagram showing a configuration of a liquid crystal panel.

FIG. 2 is a schematic cross-sectional diagram taken along the line II-II of the liquid crystal panel shown in FIG. 1.

FIG. 3 is an equivalent circuit diagram showing an electrical configuration of a liquid crystal panel.

FIG. 4 is a schematic cross-sectional diagram showing a structure of a liquid crystal panel.

FIG. 5 is a schematic plan view showing a configuration of a peripheral electrode.

FIG. 6 is a schematic diagram showing a configuration of a projection display device as a display device provided with the liquid crystal panel.

FIG. 7 is a schematic plan view showing a cooling structure of a projection display device.

FIG. 8 is a flowchart showing an operation procedure of a projection display device from rising to falling.

FIG. 9 is a graph showing the relationship of the temperature of a liquid crystal panel and lamp and time in a case where cooling of the lamp is delayed in the off sequence period.

FIG. 10 is a graph showing the relationship of the temperature of a liquid crystal panel and lamp and time in a case where the liquid crystal panel is heated in the off sequence period.

### DESCRIPTION OF EXEMPLARY EMBODIMENTS

Hereinafter, specific embodiments of the invention will be described with reference to the drawings. Moreover, the drawings to be used are displayed after enlarging or reducing as appropriate in order that the portions to be described are recognizable.

Moreover, in the following forms, for example, a case where “on a substrate” is disclosed indicates a case where arrangement is performed so as to contact the top of the substrate, a case where arrangement is performed via another constituent component on top of the substrate, and a case where a part is arranged so as to contact the top of the substrate, and a part is arranged via constituent component.

According to the present embodiment, as an electro-optical device configuring a display device, an active matrix type liquid crystal panel provided with a thin film transistor (TFT: Thin Film Transistor) as a pixel switching element will be described as an example. The liquid crystal panel may be suitably used as a light modulating element (liquid crystal light valve) in a projection display device (liquid crystal projector).

### First Embodiment

### Configuration of Liquid Crystal Panel Configuring Display Device

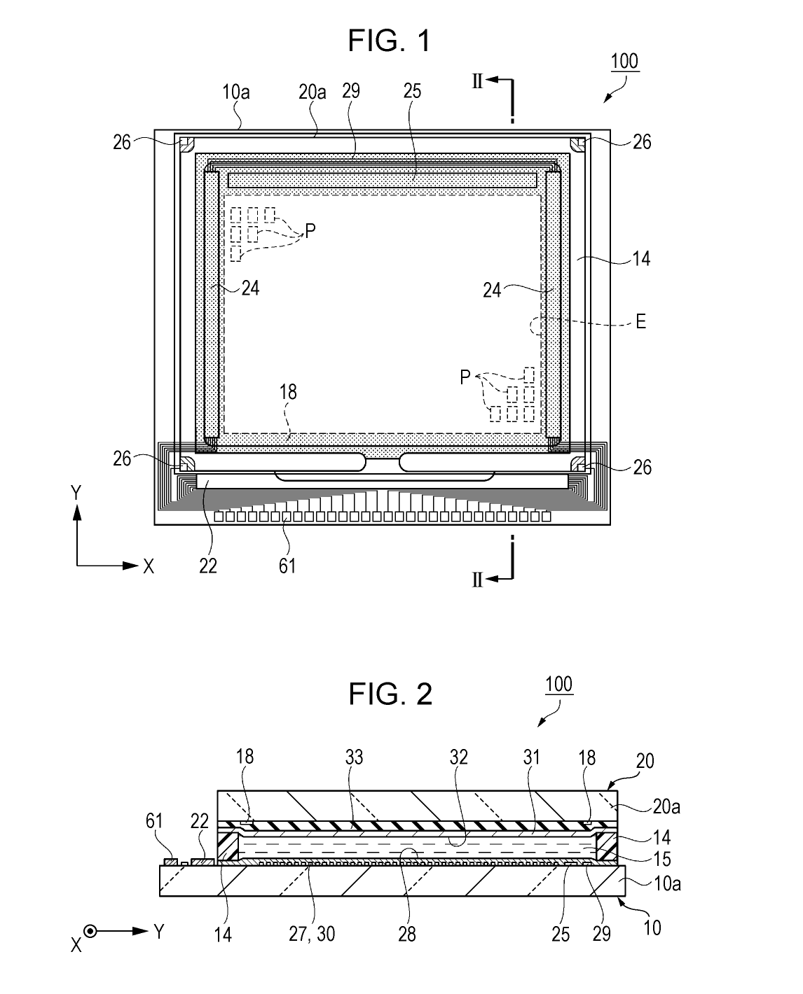

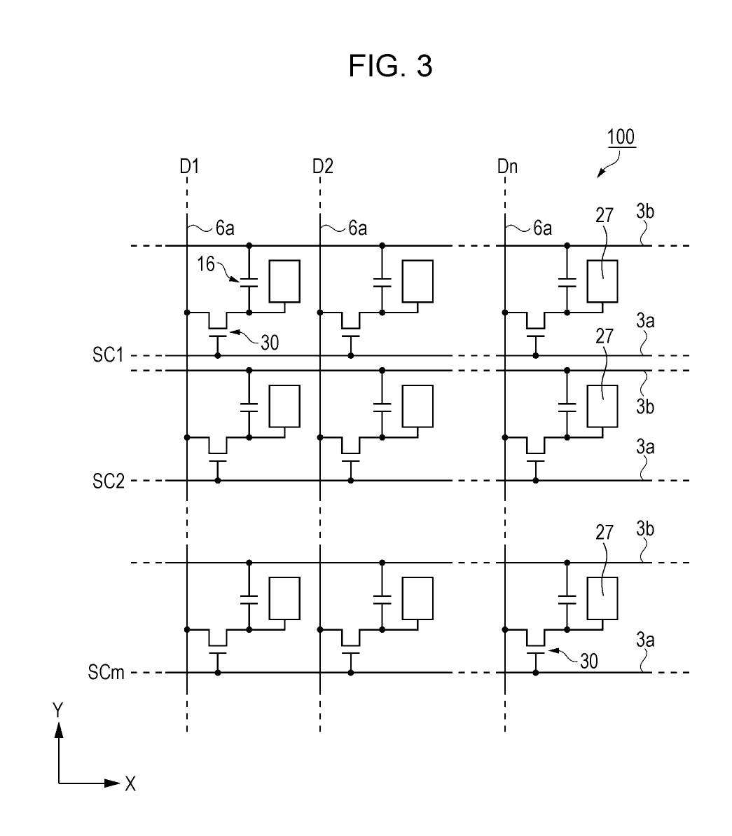

FIG. 1 is a schematic plan diagram showing a configuration of a liquid crystal panel. FIG. 2 is a schematic cross-sectional diagram taken along the line II-II of the liquid crystal panel shown in FIG. 1. FIG. 3 is an equivalent circuit diagram showing an electrical configuration of a liquid crystal panel. Below, description will be given of the configuration of the liquid crystal panel with reference to FIGS. 1 to 3.

As shown in FIGS. 1 and 2, the liquid crystal panel 100 of the present embodiment includes an element substrate 10 as a first substrate and a counter substrate 20 as a second substrate arranged opposed to each other, and a liquid crystal layer 15 interposed by the pair of substrates. A transparent substrate, for example, a glass substrate or quartz substrate or the like, is used for a first base material 10a as a substrate configuring the element substrate 10 and a second base material 20a configuring the counter substrate 20.

The element substrate 10 is larger than the counter substrate 20, and both substrates are joined via a seal material 14 arranged along the outer circumference of the counter substrate 20. A liquid crystal layer 15 is configured by sealing liquid crystal having positive or negative dielectric anisotropy in the gap. A bonding agent, such as a thermosetting or ultraviolet curable epoxy resin, for example, is employed as the seal material 14. A spacer (not shown in the diagram) is mixed into the seal material 14 for holding the gap between the pair of substrates constant.

A pixel region E (display region) in which a plurality of pixels P is arranged is provided on the inside of the seal material 14. The pixel region E includes dummy pixels arranged so as to surround a plurality of pixels P in addition to the plurality of pixels P contributing to display. In addition, although not shown in FIGS. 1 and 2, a light shielding portion (black matrix: BM) dividing the plurality of pixels P in the pixel region E from one another in a planar manner is provided on the counter substrate 20.

A data line driving circuit 22 is provided between the seal material 14 along a first peripheral portion of the element substrate 10 and the first peripheral portion. In addition, a test circuit 25 is provided between the seal material 14 along another peripheral portion opposed to the first peripheral portion and the pixel region E. Furthermore, a scanning line driving circuit 24 is provided between the seal material 14 along another second peripheral portion mutually orthogonally opposed to the first peripheral portion and the pixel region E. A plurality of wirings 29 connecting two scanning line driving circuits 24 are provided between the seal material 14 along another first peripheral portion opposite the first peripheral portion and the test circuit 25.

Inside of the seal material 14 arranged in a frame shape on the counter substrate 20 side, a light shielding portion 18 (partition portion) is provided in the same frame shape. The light shielding portion 18, for example, is formed from a metal or metallic oxide with light shielding properties, and the inside of the light shielding portion 18 becomes the pixel region E having a plurality of pixels P. Moreover, although not shown in FIG. 3, a light shielding portion dividing the plurality of pixels P in a planar manner is also provided in the pixel region E.

The wirings connecting the data line driving circuit 22 and scanning line driving circuit 24 are connected to a plurality of external connection terminals 61 arranged along the first peripheral portion. Hereinafter, description will be made with the direction along the first peripheral portion is set as the X direction, and the direction along the other second peripheral portions mutually orthogonally opposed to the first peripheral portion set as the Y direction. Moreover, the arrangement of the test circuit 25 is not limited thereto, and may be provided between the seal material 14 along the data line driving circuit 22 and the pixel region E.

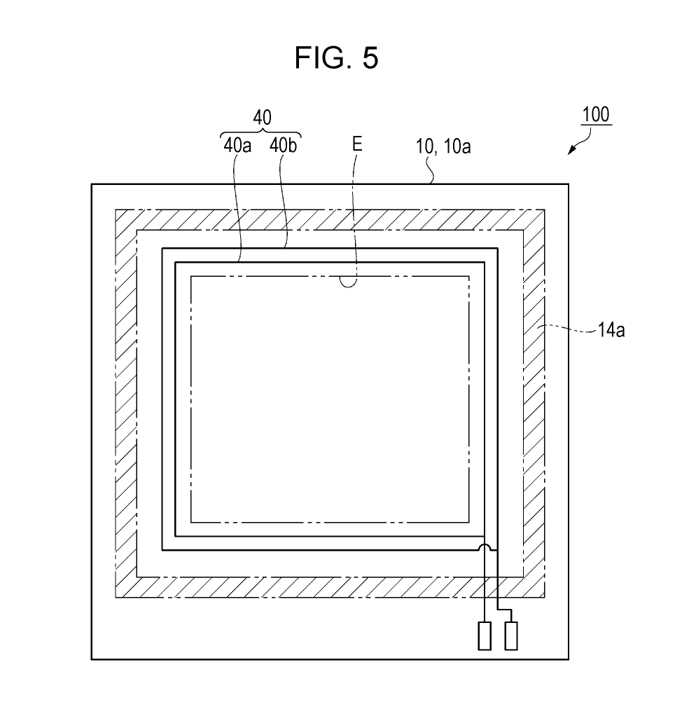

In addition, although not shown in the diagram, so as to surround the pixel region E, a peripheral electrode 40 (refer to FIG. 5) is provided between the pixel region E and seal material 14 so as to surround the pixel region E. The peripheral electrode 40, for example, is configured by a pair of peripheral electrodes 40 (first peripheral electrode 40a and second peripheral electrode 40b) and is provided in order to suppress the diffusion of ionic impurities in the pixel region E. The peripheral electrode 40 will be described in detail below.

As shown in FIG. 2, a transparent pixel electrode 27 provided for each pixel P and a thin film transistor (TFT: Thin Film Transistor, hereinafter, referred to as “TFT 30”) which is a switching element, a signal wiring, and a first alignment film 28 covering these are formed on the surface of the liquid crystal layer 15 side of the first base material 10a.

In addition, a light shielding structure preventing a switching operation by light being incident on the semiconductor layer in the TFT 30 becoming unstable is employed. The element substrate 10 of the invention includes at least a pixel electrode 27, a TFT 30, a signal wiring and a first alignment film 28.

A light shielding portion 18, a planarizing layer 33 formed as a film so as to cover the light shielding portion 18, a common electrode 31 formed so as to cover the planarizing layer 33, and a second alignment film 32 covering the common electrode 31 are provided on the surface of the liquid crystal layer 15 side of the counter substrate 20. The counter substrate 20 in the invention includes at least the light shielding portion 18, the common electrode 31 and the second alignment film 32.

The light shielding portion 18 is provided at a position overlapping the scanning line driving circuit 24 and test circuit 25 in a planar manner, and encompasses the pixel region E as shown in FIG. 1. In so doing, the light from the counter substrate 20 side incident on the peripheral circuit including these driving circuits is blocked, and the peripheral circuit fulfills a role preventing misoperations due to light. In addition, unneeded stray light is blocked from being incident on the pixel region E, and high contrast in the display of the pixel region E is secured.

The planarizing layer 33 is formed from an inorganic material, such as, for example, silicon oxide, and is provided so as to cover the light shielding portion 18 having optical transparency. Examples of the forming method of such a planarizing layer 33 include methods forming films using, for example, a plasma CVD (Chemical Vapor Deposition) method or the like.

the common electrode 31 is formed from a transparent conductive film such as ITO (Indium Tin Oxide), for example, and is electrically connected to the wiring of the element substrate 10 side by a vertical conduction portion 26 provided at four corners of the counter substrate 20 as shown in FIG. 1, and covers the planarizing layer 33.

The first alignment film 28 covering the pixel electrode 27 and the second alignment film 32 covering the common electrode 31 are selected based on the optical design of the liquid crystal panel 100. Examples include an organic alignment film in which an organic material, such as polyimide, is formed as a film, and subjected to an approximately horizontal alignment treatment with respect to liquid crystal molecules having positive dielectric anisotropy by rubbing the surface thereof, or an inorganic alignment film in which an inorganic material such as SiOx (silicon oxide) is formed as a film using a vapor-phase growth method and liquid crystal molecules having negative dielectric anisotropy are caused to be approximately vertically aligned, for example. In the embodiment, the inorganic alignment film is employed as the first alignment film 28 and the second alignment film 32.

Such a liquid crystal panel 100 is, for example, a transmissive-type, and employs an optical design with a normally white mode which displays brightly when the pixels P are not driven, or a normally black mode which displays darkly when the pixels P are not driven. Polarizing elements are used by being respectively arranged on the light incident side or emission side according to the optical design. The embodiment employs a normally black mode.

As shown in FIG. 3, the liquid crystal panel 100 includes at least a plurality of scanning lines 3a and a plurality of data lines 6a mutually insulated and orthogonal in the pixel region E, and a capacitance line 3b. The direction in which the scanning line 3a extends is the X direction and the direction in which the data line 6a extends is the Y direction.

In the scanning line 3a, data line 6a and capacitance line 3b, and in a region divided by these signal line types, a pixel electrode 27, a TFT 30 and capacitive element 16 are provided, and these configure a pixel circuit of the pixel P.

The scanning line 3a is electrically connected to the gate of the TFT 30, and the data line 6a is electrically connected to the data line side source-drain region (source region) of the TFT 30. The pixel electrode 27 is electrically connected to the pixel electrode side source-drain region (drain region) of the TFT 30.

The data line 6a is connected to a data line driving circuit 22 (refer to FIG. 1), and supplies image signals D1, D2, . . . Dn supplied from the data line driving circuit 22 to the pixel P. The scanning line 3a is connected to the scanning line driving circuit 24 (refer to FIG. 1), and supplies scanning signals SC1, SC2, . . . , SCm supplied from the scanning line driving circuit 24 to each pixel P.

The image signals D1 to Dn supplied to the data line 6a from the data line driving circuit 22 may be supplied in line sequence in this order, or may be supplied to each group with respect to each of a plurality of mutually adjacent data lines 6a. The scanning line driving circuit 24 supplies scanning signals SC1 to SCm in a pulsed manner in line-sequence at predetermined timing with respect to the scanning line 3a.

The liquid crystal panel 100 has a configuration in which the image signals D1 to Dn supplied from the data line 6a are written to the pixel electrode 27 at a predetermined timing by being set to an on state for a certain period only due to input of the scanning signals SC1 to SCm by the TFT 30 which is a switching element. Additionally, the image signals D1 to Dn with a predetermined level written to the liquid crystal layer 15 via the pixel electrode 27 are held for a certain period between the pixel electrode 27 and the common electrode 31 arranged opposed thereto with the liquid crystal layer 15 interposed.

In order to prevent leaking of the held image signals D1 to Dn, a capacitive element 16 is connected in parallel to a liquid crystal capacitance formed between the pixel electrode 27 and the common electrode 31. The capacitive element 16 is provided between the pixel electrode side source-drain region of the TFT 30 and the capacitance line 3b. The capacitive element 16 includes a dielectric layer between two capacitance electrodes.

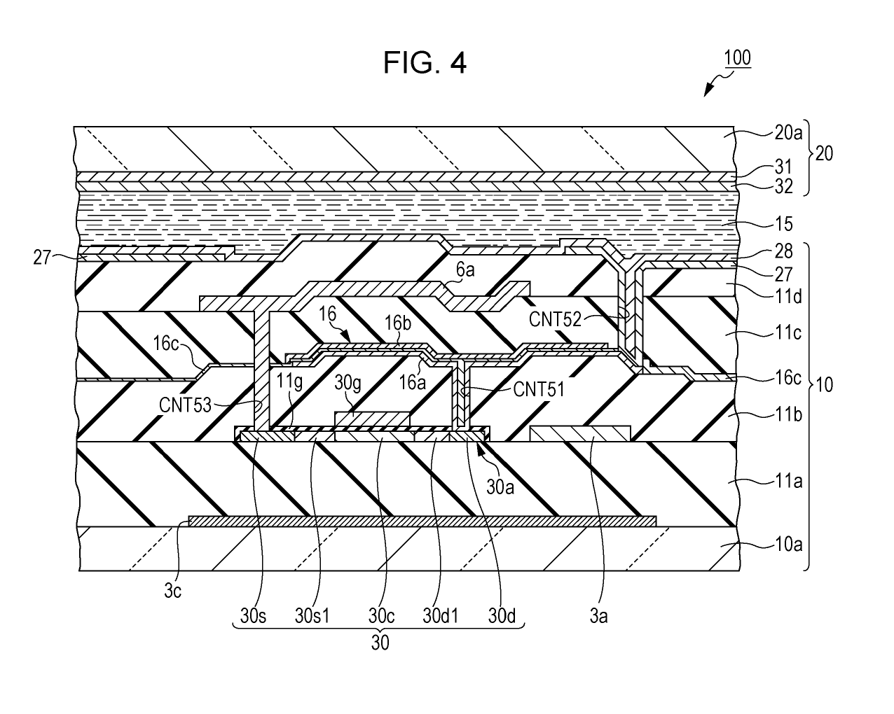

FIG. 4 is a schematic cross-sectional diagram showing the structure of a liquid crystal panel. Below, description will be given of the structure of the liquid crystal panel with reference to FIG. 4. Moreover, FIG. 4 shows the cross-sectional positional relationship of each constituent element, which are represented at a scale which can be understood clearly.

As shown in FIG. 4, the liquid crystal panel 100 is provided with an element substrate 10 which is one of a pair of substrates, and a counter substrate 20 which is the other of the pair of substrates arranged opposed thereto. The first base material 10a configuring the element substrate 10 and the second base material 20a configuring the counter substrate 20 are configured from, for example, a quartz substrate or the like, as described above.

A lower light shielding film 3c formed from titanium (Ti), chromium (Cr) or the like is formed on the first base material 10a. The lower light shielding film 3c is patterned in a planar manner in a matrix shape, and regulates the opening region of each pixel. Moreover, the lower light shielding film 3c may function as a portion of the scanning line 3a. An underlying insulating layer 11a formed from a silicon oxide film or the like is formed on the first base material 10a and the lower light shielding film 3c.

A TFT 30 and scanning line 3a, and the like, are formed on the underlying insulating layer 11a. The TFT 30 includes, for example, an LDD (Lightly Doped Drain) structure, and includes a semiconductor layer 30a formed from polysilicon or the like, a gate insulating film 11g formed on the semiconductor layer 30a and a gate electrode 30g formed from a polysilicon film, or the like, formed on the gate insulating film 11g. The scanning line 3a also functions as a gate electrode 30g, as above.

The semiconductor layer 30a is formed as an N-type TFT 30 by, for example, N-type impurity ions, such as phosphorous (P) ions, being injected. Specifically, the semiconductor layer 30a is provided with a channel region 30c, a data line side LDD region 30s1, a data line side source-drain region 30s, a pixel electrode side LDD region 30d1 and a pixel electrode side source-drain region 30d.

P-type impurity ions, such as boron (B) ions, are doped in the channel region 30c. N-type impurity ions, such as phosphorus (P) ions, are doped in the other regions (30s1, 30s, 30d1, 30d). In so doing, the TFT 30 is formed as an N-type TFT.

A first interlayer insulating layer 11b formed from a silicon oxide film or the like is formed on the gate electrode 30g, underlying insulating layer 11a, and scanning line 3a. A capacitive element 16 is provided on the first interlayer insulating layer 11b. Specifically, a capacitive element 16 is formed by arranging opposed a first capacitance electrode 16a as a pixel potential side capacitance electrode electrically connected to the pixel electrode side source-drain region 30d of the TFT 30 and the pixel electrode 27, and a portion of a capacitance line 3b (second capacitance electrode 16b) as a fixed potential side capacitance electrode with a dielectric film 16c interposed.

The capacitance line 3b (second capacitance electrode 16b) is formed from, for example, a metallic simple substance including at least one high melting point metal such as Ti (titanium), Cr (chromium), W (tungsten), Ta (tantalum) or Mo (molybdenum), an alloy, a metallic silicide, polysilicide, or a layered substance thereof. Alternatively, the line may be formed from an Al (aluminum) film.

The first capacitance electrode 16a functions as a pixel potential side capacitance electrode of the capacitive element 16 formed from, for example, a conductive polysilicon film. However, the first capacitance electrode 16a, similarly to the capacitance line 3b, may be configured from a single layer film including a metal or an alloy, or a multi-layer film. The first capacitance electrode 16a includes a function of relay connecting the pixel electrode 27 and the pixel electrode side source-drain region 30d (drain region) of the TFT 30 via a contact hole CNT 51 and CNT 52, in addition to the function as a pixel potential side capacitance electrode.

A data line 6a is formed on the capacitive element 16 with the second interlayer insulating layer 11c interposed. The data line 6a is electrically connected to the data line side source-drain region 30s (source region) of the semiconductor layer 30a via the contact hole CNT 53 opened in the first interlayer insulating layer lib and second interlayer insulating layer 11c.

A pixel electrode 27 is formed on the data line 6a with a third interlayer insulating layer 11d interposed. The pixel electrode 27 is electrically connected to the pixel electrode side source-drain region 30d (drain region) of the semiconductor layer 30a by being connected to the first capacitance electrode 16a via the contact hole CNT 52 opened in the second interlayer insulating layer 11c and the third interlayer insulating layer 11d.

Moreover, the pixel electrode 27 is formed from a transparent conductive film, such as an ITO (Indium Tin Oxide) film, for example.

A first alignment film 28 in which an organic material such as silicon oxide (SiO₂) is obliquely evaporated is provided on the pixel electrode 27 and the third interlayer insulating layer 11d. A liquid crystal layer 15 in which a liquid crystal or the like is sealed in the space surrounded by the seal material 14 (refer to FIG. 4) is provided on the first alignment film 28.

On the other hand, a common electrode 31 is provided across the entire face on the second base material 20a. A second alignment film 32 in which an organic material such as silicon oxide (SiO₂) is obliquely evaporated is provided on the common electrode 31 (lower side in FIG. 4). The common electrode 31, similarly to the pixel electrode 27 described above, is formed from a transparent conductive film, such as an ITO film, for example.

The liquid crystal layer 15 takes a predetermined alignment state due to the first alignment film 28 and the second alignment film 32 in a state in which an electrical field from the pixel electrode 27 is not applied. The seal material 14, in order to bond the element substrate 10 and the counter substrate 20 at the peripheries thereof, is a bonding agent formed from, for example, a photo-curing resin or a thermosetting resin, and a spacer, such as glass fibers or glass beads, is mixed therein in order to set the distance between both substrates to a predetermined value.

### Configuration of Peripheral Electrode

FIG. 5 is a schematic plan view showing a configuration of a peripheral electrode. Below, description will be given of the configuration of the peripheral electrode with reference to FIG. 5.

As shown in FIG. 5, a peripheral electrode 40 is provided on the periphery of the pixel region E of the liquid crystal panel 100. As described above, the peripheral electrode 40 is arranged with a first peripheral electrode 40a configuring a pair of peripheral electrodes 40, and a second peripheral electrode 40b arranged on the periphery of the first peripheral electrode 40a.

The distance between the pair of peripheral electrodes 40 and pixel region E is, for example, 200 μm. The gap between the first peripheral electrode 40a and the second peripheral electrode 40b is, for example 5 μm. The width of the first peripheral electrode 40a or the second peripheral electrode 40b is, for example, 10 μm.

The first peripheral electrode 40a and the second peripheral electrode 40b are, for example, provided in the same layer as the pixel electrode 27 (refer to FIG. 4) and formed from an ITO film. In addition, a seal drawing region 14a which is a region drawing the seal material 14 is included at the periphery of the pair of peripheral electrodes 40.

In addition, it is desirable that the portion where the first peripheral electrode 40a and the second peripheral electrode 40b intersect be electrically connected to either wiring via a metallic wiring layer provided on a lower layer thereof (dragging in a bridge-shape).

In such a configuration, by applying different voltages to the first peripheral electrode 40a and the second peripheral electrode 40b, a potential difference is able to be generated at the periphery of the pixel region E, and it is possible to suppress diffusion of ionic impurities in the pixel region E. Specifically, a direct current of 0 V, for example, is applied to the first peripheral electrode 40a arranged on the pixel region E side. A direct current of −5 V, for example, is applied to the second peripheral electrode 40b arranged at the outside of the first peripheral electrode 40a.

In addition, the affinity of ionic impurities and the inorganic alignment film is high and the ionic impurities are considered to easily gather in the pixel region E; however, since the peripheral electrode 40 is formed on the periphery of the pixel region E, it is possible to suppress diffusion of the ionic impurities in the pixel region E. Thus, it is possible to suppress degradation of the display quality.

As described above, since a voltage is applied to the pair of peripheral electrodes 40 and an electric field is generated, positive (+) ionic impurities set as impurities are trapped in the peripheral electrode 40, and it is possible to suppress spreading from the outside to the inside of the liquid crystal panel 100. Specifically, the liquid crystal is retained in the pixel region E, and it is possible to suppress the ionic impurities from entering the pixel region E by the pair of peripheral electrodes 40a and 40b.

### Configuration of Display Device

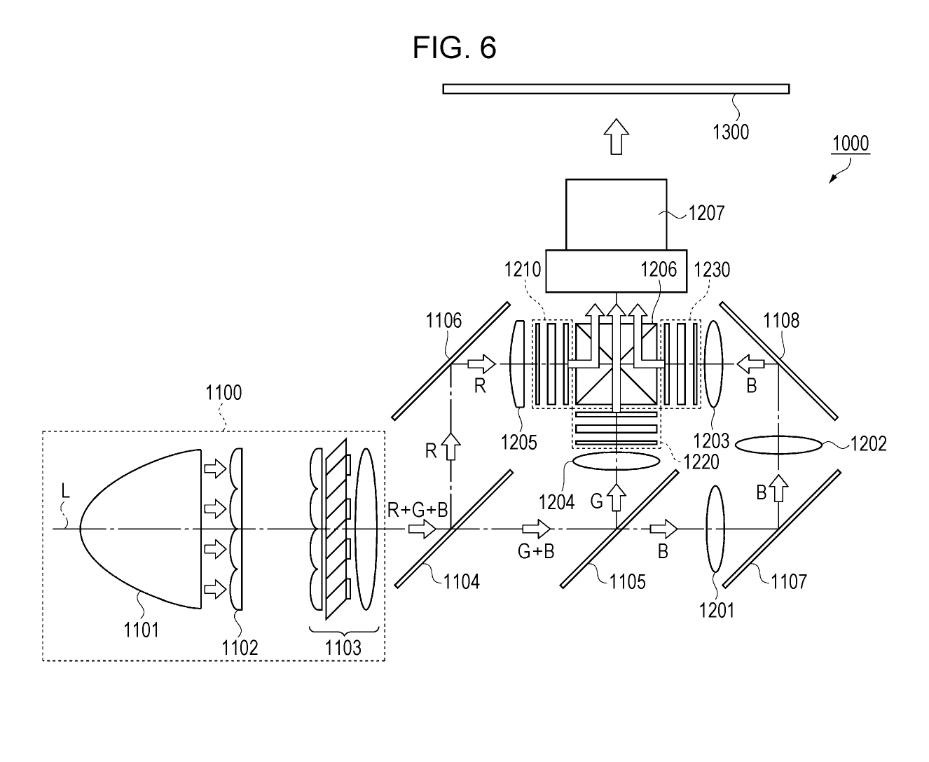

Next, a projection display device as a display device of the present embodiment will be described by referring to FIG. 6. FIG. 6 is a schematic diagram showing a configuration of a projection display device provided with the liquid crystal panel.

As shown in FIG. 6, the projection display device 1000 of the present embodiment is provided with a polarized illumination device 1100 arranged along a system optical axis L, two dichroic mirrors 1104 and 1105 as optical separation elements, three reflection mirrors 1106, 1107, and 1108, five relay lenses 1201, 1202, 1203, 1204, and 1205, transmissive-type liquid crystal light valves 1210, 1220, and 1230 as 3 light modulation units, a cross dichroic prism 1206 as a light synthesizing element, and a projection lens 1207.

The polarized illumination device 1100 is schematically configured from a lamp unit 1101 as a light source formed from a white light source, such as an ultrahigh pressure mercury lamp or halogen lamp (lamp 1101 as a light source), an integrator lens 1102 and a polarization conversion element 1103.

The dichroic mirror 1104 causes red light (R) to reflect, and causes green light (G) and blue light (B) to transmit from the polarized luminous fluxes emitted from the polarized illumination device 1100. Another dichroic mirror 1105 causes green light (G) transmitting the dichroic mirror 1104 to reflect and causes blue light (B) to transmit.

The red light (R) reflected by the dichroic mirror 1104 is incident on the liquid crystal light valve 1210 through the relay lens 1205 after being reflected by the reflection mirror 1106. The green light (G) reflected by the dichroic mirror 1105 is incident on the liquid crystal light valve 1220 through the relay lens 1204. The blue light (B) transmitted by the dichroic mirror 1105 is incident on the liquid crystal valve 1230 through a light guiding system formed from three relay lenses 1201, 1202 and 1203 and two reflection mirrors 1107 and 1108.

The liquid crystal light valves 1210, 1220, and 1230 are respectively arranged opposed with respect to the incident surface for each colored light of the cross dichroic prism 1206. The colored light incident on the liquid crystal light valves 1210, 1220, and 1230 is emitted towards the cross dichroic prism 1206 and modulated based on the video information (video signal).

This prism is formed by bonding 4 right-angle prisms, and a cross-shape is formed by a dielectric multilayer reflecting red light and a dielectric multilayer reflecting blue light on the inner surface thereof. Three colors of light are synthesized by these dielectric multilayers, and light showing a color image is synthesized. The synthesized light is projected on a screen 1300 by a projection lens 1207 that is a projection optical system, and the image is displayed by being enlarged.

The liquid crystal light valve 1210 is applied to the liquid crystal panel 100 described above. The liquid crystal panel 100 is arranged by being placed in the gap between a pair of polarization elements arranged in a cross Nicol arrangement in the colored light of the incident side and the emission side. The same applies to other liquid crystal light valves 1220 and 1230.

According to such a projection display device 1000, since the liquid crystal panel 100 in which display unevenness, image burn-in or the like caused by ionic impurities is reduced is used as the liquid crystal light valve 1210, 1220 and 1230, it is possible to realize high display quality and reliability.

### Cooling Structure of Display Device

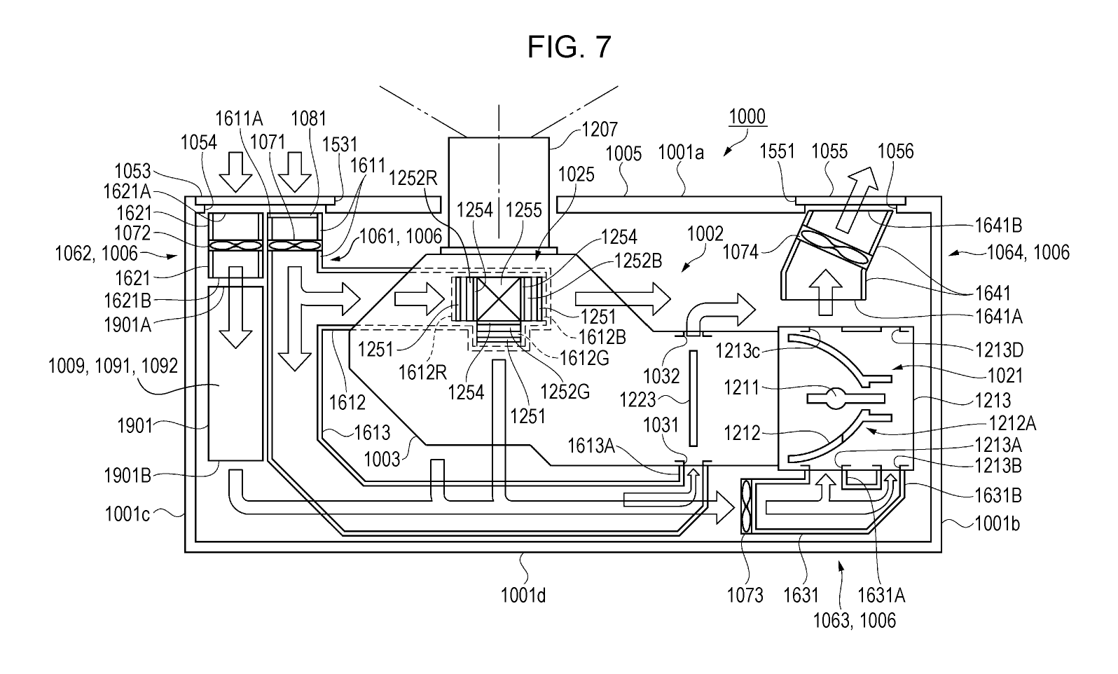

FIG. 7 is a schematic plan view showing a cooling structure of a projection display device as a display device. Below, a cooling structure of a projection display device will be described with reference to FIG. 7. Moreover, FIG. 7 indicates the flow direction of air due to operation of the cooling mechanism with an arrow.

An intake cover 1053 and an exhaust cover 1055 with the projection lens 1207 are provided in the front surface 1001a of the projection display device 1000. Accordingly, an intake opening portion 1054 and exhaust opening portion 1056 described below are installed interposing the projection lens 1207.

The intake cover 1053 is fixed to an intake cover fixing portion 1531 formed on the outer case 1005. In addition, an intake opening portion 1054 is formed in the intake cover fixing portion 1531. The intake opening portion 1054 is an opening portion intaking external air external to the projection display device 1000. Moreover, in the projection display device 1000 of the embodiment, an opening portion intaking external air other than the intake opening portion 1054 is not installed.

The exhaust cover 1055 is fixed to an exhaust cover fixing portion 1551 formed on the outer case 1005. In addition, an exhaust opening portion 1056 is formed in the exhaust cover fixing portion 1551. The exhaust opening portion 1056 is an opening portion exhausting internal air internal to the projection display device 1000. Moreover, in the projection display device 1000 of the embodiment, an opening portion exhausting internal air other than the exhaust opening portion 1056 is not installed.

The cooling mechanism 1006 is a mechanism cooling members generating heat inside the projection display device 1000. The cooling mechanism 1006 is configured to include a first cooling unit 1061, a second cooling unit 1062, a third cooling unit 1063 and a fourth cooling unit 1064.

The first cooling unit 1061 mainly cools the optical device 1025 and polarization conversion element 1223 configuring the optical unit 1002. The second cooling unit 1062 cools the power source unit 1009. Moreover, the power source unit 1009 is configured to include a power source device 1091 providing electrical power to each portion, and a ballast 1092 providing electrical power to light source device 1021.

A third cooling unit 1063 cools the light source device 1021. The third cooling unit 1063 cools the light source device 1021 by intaking warmed air (internal air) ejected to the inside of the outer case 1005 by the operation of the first cooling unit 1061 and the second cooling unit 1062. The fourth cooling unit 1064 exhausts warmed internal air stripped of heat and ejected by the first cooling unit 1061, the second cooling unit 1062 and the third cooling unit 1063 to the outside of the external case 1005 (outside of the projection display device 1000). Moreover, an IC (not shown in the diagram) or the like emitting heat of the circuit unit is cooled by stripping heat, along with cooling the optical unit 1002 or the power source unit 1009 due to the operation of the fourth cooling unit 1064. The interior of the projection display device 1000 is appropriately cooled by the operation of the first cooling unit 1061 to the fourth cooling unit 1064.

The first cooling unit 1061 is provided with a first duct 1611 and the second cooling unit 1062 is provided with a second duct 1621. A first intake port 1611A of the first duct 1611 and a second intake port 1621A of the second duct 1621 are installed opposing the intake opening portion 1054 formed in the front surface 1001a of the projection display device 1000.

The first cooling portion 1061 is provided with a first intake fan 1071 as a cooling unit by which intake is performed, in addition to the first duct 1611 described above. The first intake fan 1071 is installed in the vicinity of the first intake port 1611A of the first duct 1611. The first duct 1611 of the latter stage first intake fan 1071 is branched into a first sub-duct 1612 and a second sub-duct 1613.

The first sub-duct 1612 is a duct for cooling the optical device 1025. The first sub-duct 1612 reaches the lower region of the optical device 1025 through the lower side of the optical component case 1003, and three ejection ports 1612R, 1612G and 1612B are formed at the tip portion thereof. The ejection port 1612R is formed on the lower side of the R light liquid crystal panel 1252R, the incident side polarization plate 1251 positioned at an earlier stage, and the emission side polarization plate 1254 position at a later stage.

Similarly, the ejection port 1612G is formed on the lower side of the G light liquid crystal panel 1252G, the incident side polarization plate 1251 positioned at an earlier stage, and the emission side polarization plate 1254 position at a later stage. Similarly, the ejection port 1612B is formed on the lower side of the B light liquid crystal panel 1252B, the incident side polarization plate 1251 positioned at an earlier stage, and the emission side polarization plate 1254 position at a later stage. Moreover, opening portions not shown in the diagram are formed in the lower surface of the optical component case 1003 opposite the three ejection ports 1612R, 1612G and 1612B.

The second sub-duct 1613 is a duct for cooling the polarization conversion element 1223. The second sub-duct 1613 reaches the side face region of the polarization conversion element 1223 through the side face of the optical component case 1003, and an ejection port 1613A is formed at the tip portion thereof. An opening portion 1031 is formed in the side face (side face of the rear surface 1001d side) of the optical component case 1003 opposite the ejection port 1613A. In addition, an opening portion 1032 is also formed in the other side face (side face of the front surface 1001a side) of the optical component case 1003 opposite the opening portion 1031.

Description will be made relating to the operation of the first cooling unit 1061. Through rotation of the first intake fan 1071, the external air external to the outer case 1005 is taken in from the first intake port 1611A to the inside of the first duct 1611 via the intake cover 1053 and the intake opening portion 1054. At this time, the external air passes through a filter 1081 installed at the first intake port 1611A. Through external air passing through the filter 1081, dust included in the external air is purified. Accordingly, the purified external air flows in the first duct 1611.

A portion of the external air which passed through the first intake fan 1071 flows into the first sub-duct 1612. The external air which flowed in the first sub-duct 1612 is ejected upward from the three ejection ports 1612R, 1612G and 1612B. The external air ejected from the ejection port 1612R is blown against the R light liquid crystal panel 1252R of the optical device 1025 positioned upward, the incident side polarization plate 1251 and the emission side polarization plate 1254 and is blown through the upper portion of the optical component case 1003. In so doing, the external air cools the R light liquid crystal panel 1252, incident side polarization plate 1251 and the emission side polarization plate 1254 by stripping heat generated by the R light liquid crystal panel 1252, incident side polarization plate 1251 and the emission side polarization plate 1254. The external air ejected from the other ejection ports 1612G and 1612B, by operating similarly to the external air ejected from the ejection port 1612R, also cools the optical device 1025 by external air flowing in the first sub-duct 1612.

In addition, the other portion of the external air which passed through the first intake fan 1071 flows into the second sub-duct 1613. The external air which flowed in the second sub-duct 1613 is ejected to the opening portion 1031 of the optical component case 1003 from the ejection port 1613A. The external air which flowed to the inside of the optical component case 1003 from the opening portion 1031 blows onto the side face of the polarization conversion element 1223 and blows through from the opening portion 1032. In so doing, the external air cools the polarization conversion element 1223 by stripping heat generated by the polarization conversion element 1223. Though the above, the first cooling unit 1061 cools the optical device 1025 and the polarization conversion element 1223.

The second cooling portion 1062 is provided with a second intake fan 1072 by which intake is performed, in addition to the second duct 1621 described above. The second intake fan 1072 is installed in the vicinity of the second intake port 1621A of the second duct 1621. The second duct 1621 of the latter stage second intake fan 1072 is installed so that the ejection port 1621B is opposite the power source unit 1009 (power source device 1091 and ballast 1092). Moreover, the second intake fan 1072 is employed as an axial flow fan in the embodiment. The axial flow fan has a structure ejecting air intake from the rotational axis direction in the rotational axis direction.

Description will be made relating to the operation of the second cooling unit 1062. Through rotation of the second intake fan 1072, the external air external to the outer case 1005 is taken in from the second intake port 1621A to the inside of the second duct 1621 via the intake cover 1053 and the intake opening portion 1054. The external air which passed through the second intake fan 1072 is ejected from the ejection port 1621B by flowing inside the latter stage second sub-duct 1621 of the second intake fan 1072. The external air ejected from the ejection port 1621B blows through the power source unit 1009 (power source device 1091 and ballast 1092) opposite the ejection port 1621B.

The power source 1009 is arranged inside a shielding case 1901 formed in a nearly cylindrical shape. The external air ejected from the ejection port 1621B flows inside the case 1901 by flowing from the opening 1901A of one side of the case 1901, strips the heat generated by each electrical element (not shown in the diagram) configuring the power source device 1091 and the ballast 1092, and blows through from the opening 1901B of the other side of the case 1901. In so doing, the external air cools the power source device 1091 and the ballast 1092. Though the above, the second cooling unit 1062 cools the power source unit 1009.

The third cooling unit 1063 is provided with a third intake fan 1073 and a third duct 1631. The third cooling unit 1063 is installed crossing the optical component case 1003 and the side face (side face of the rear surface 1001d side) of the light source device 1021. The third intake fan 1073 is employed as a sirocco fan in the embodiment. The third duct 1631 is installed at a later stage of the third intake fan 1073, reaches the side face of the light source device 1021 (side face of the rear surface 1001d side) from the side face of the optical component case 1003 (side face of the rear surface 1001d side), and two ejection ports 1631A and 1631B are formed.

Moreover, the light source device 1021 is accommodated in a box-like case 1213. In the side face of the case 1213 (side face of the rear surface 1001d side), an opening portion 1213A is formed opposite the light source lamp 1211 (lamp 1101), and an opening portion 1213B is formed opposite the neck portion 1212A of the reflector 1212. In addition, in the other side face of the case 1213 (side face of the front surface 1001a side), an opening portion 1213C is formed opposite the light source lamp 1211, and an opening portion 1213D is formed opposite the neck portion 1212A of the reflector 1212.

The ejection port 1631A of the third duct 1631 is installed opposite the opening portion 1213A of the case 1213. In addition, the ejection port 1631B of the third duct 1631 is installed opposite the opening portion 1213B of the case 1213.

Description will be made relating to the operation of the third cooling unit 1063. Through rotation of the third intake fan 1073, warmed air (internal air) ejected to the inside of the outer case 1005 by the operation of the first cooling unit 1061 and the second cooling unit 1062 or internal air at the periphery of the third intake fan 1073 is taken in, and caused to flow inside the third duct 1631. The internal air which flowed in the third duct 1631 is ejected the two ejection ports 1631A and 1631B.

The internal air ejected from the ejection port 1631A flows into the opening portion 1213A of the case 1213 opposite the ejection port 1631A. The internal air which flowed inside the case 1213 from the opening portion 1213A flows on the inner surface side of the reflector 1212 of the light source device 1021, strips heat generated by the light source lamp 1211, and blows through from the opening portion 1213C of the case 1213. In so doing, the internal air cools the light source lamp 1211.

On the other hand, the internal air ejected from the ejection port 1631B flows into the opening portion 1213B of the case 1213 opposite the ejection port 1631B. The internal air which flowed inside the case 1213 from the opening portion 1213B flows on the outer surface side of the reflector 1212 of the light source device 1021, strips heat generated at the center of the neck portion 1212A, and blows through from the opening portion 1213D of the case 1213. In so doing, the internal air cools the outer surface side of the reflector 1212 including the neck portion 1212A. Through the above, the third cooling unit 1063 cools the light source unit 1021.

Moreover, the third cooling unit 1063 cools the light source device 1021 using warmed air (internal air) ejected to the inside of the outer case 1005 by the operation of the first cooling unit 1061 and the second cooling unit 1062 or internal air at the periphery of the third intake fan 1073, or the like. Since the temperature of the cooled light source device 1021 is high compared to the temperature of the internal air, sufficient lowering of the temperature of the light source device 1021 is possible by the temperature of internal air.

The fourth cooling unit 1064 is provided with an exhaust duct 1641 and an exhaust fan 1074. The fourth cooling unit 1064 is installed crossing the side face (side face of the front surface 1001a side) of the light source device 1021 and the exhaust opening portion 1056. The exhaust fan 1074 is installed partway along the exhaust duct 1641. The exhaust fan 1074 is employed as an axial flow fan in the embodiment. In the exhaust duct 1641 at an earlier stage of the exhaust fan 1074, an intake port 1641A is formed at the side surface side of the light source device 1021 (side surface of the front surface 1001a side). An exhaust port 1641B is formed opposite the exhaust opening portion 1056 in the exhaust duct 1641 at a later stage of the exhaust fan 1074.

Moreover, the exhaust duct 1641 at a later stage of the exhaust fan 1074 is installed such that the internal air flowing inside the exhaust duct 1641 becomes reversed in direction with respect to the direction of the intake opening portion 1054 (first opening portion). In more detail, in the embodiment, the exhaust duct 1641 is installed inclined such that the exhaust duct 1641 becomes reversed to the direction of the intake opening portion 1054.

Description will be made relating to the operation of the fourth cooling unit 1064. Through rotation of the exhaust fan 1074, warmed air (internal air) ejected to the inside of the outer case 1005 by the operation of the first cooling unit 1061, the second cooling unit 1062 and the third cooling unit 1063 is taken in, and caused to flow inside the exhaust duct 1641. The internal air which flowed in the exhaust duct 1641 is ejected (exhaust) to the outside of the outer casing 1005 (outside the projection display device 1000) from the exhaust port 1641B via the exhaust opening portion 1056 and the exhaust cover 1055. Moreover, the exhaust direction when the internal air is exhausted to the outside of the projection display device 1000 becomes opposite in direction with respect to the direction of the intake opening portion 1054 (first opening portion). In more detail, the exhaust direction is exhausted in a direction inclined in the direction of the left surface 1001b when seen from the front surface 1001a.

Moreover, through rotation of the exhaust fan 1074, warmed air (internal air) or the like, due to heat generation from the IC (not shown in the diagram) of a circuit unit, for example, inside the outer case 1005, other than warmed air (internal air) ejected to the inside of the outer case 1005 by the operation of the first cooling unit 1061, the second cooling unit 1062 and the third cooling unit 1063, is taken in, and ejected (exhaust) in the same manner from the exhaust port 1641B.

As described above, an IC (not shown in the diagram) for emitting heat of the circuit unit, other members, or the like are cooled by exhausting warmed air (internal air) inside the outer case 1005 to the outside of the projection display device 1000, along with cooling the optical unit 1002 or the power source unit 1009 due to the operation of the fourth cooling unit 1064.

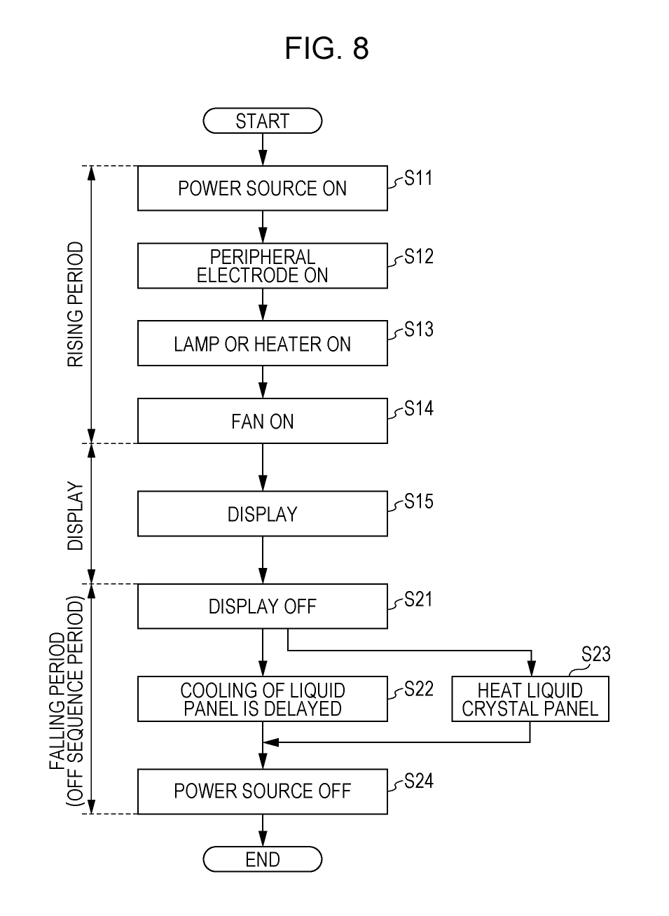

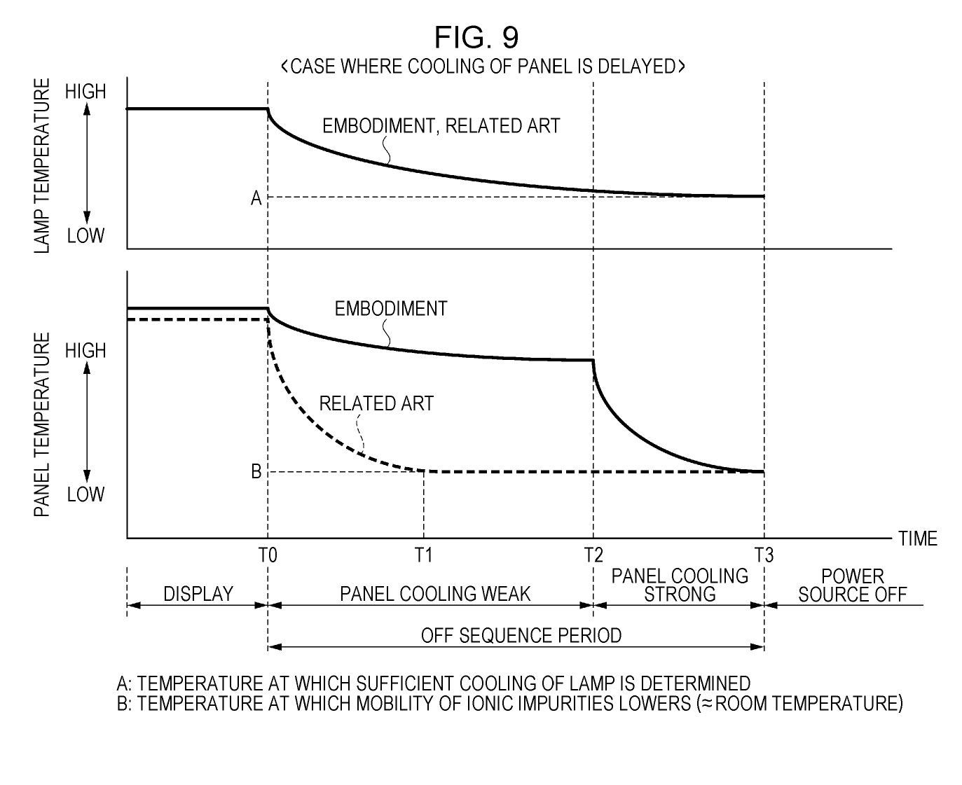

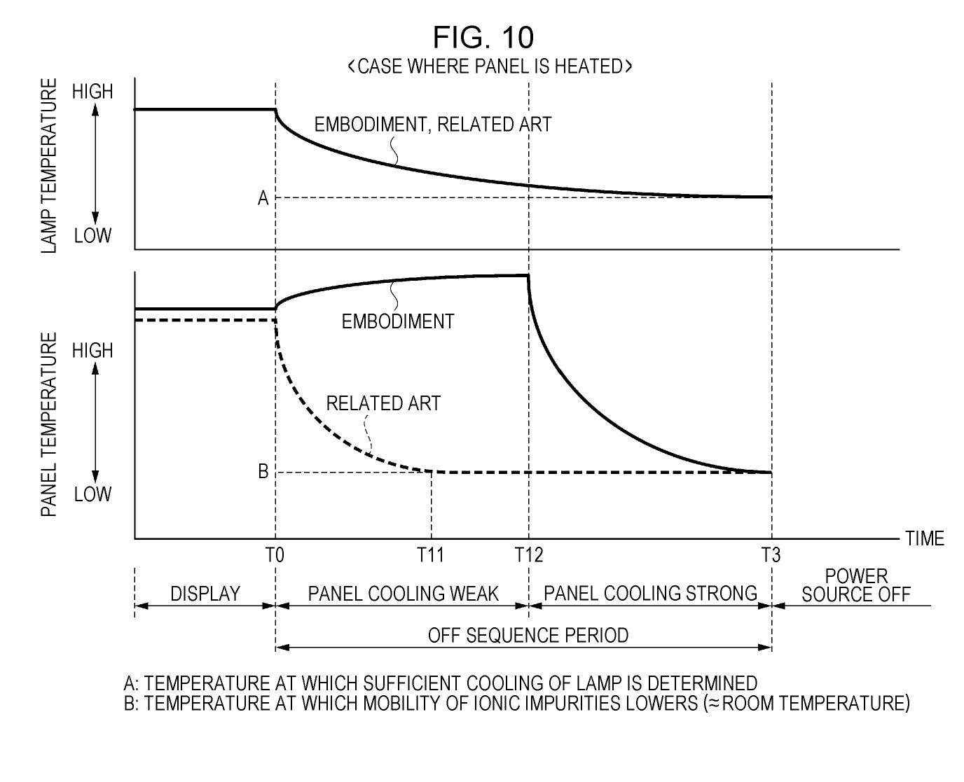

FIG. 8 is a flowchart showing an operation procedure of a projection display device from rising to falling. FIG. 9 is a graph showing the relationship between the temperature of a liquid crystal panel and lamp and the time in a case where cooling of the lamp is delayed in the falling period (off sequence period). FIG. 10 is a graph showing the relationship between the temperature of a liquid crystal panel and lamp and the time in a case where the liquid crystal panel is heated in the falling period (off sequence period). Below, the rising and falling method, and the relationship between the temperature of the lamp and liquid crystal panel and the time will be described referring to FIGS. 8 to 10.

As shown in FIG. 8, first, the power source of the projection display device 1000 is turned on, in Step S11. Moreover, the rising period of the projection display device 1000 begins from this.

In Step S12, a voltage is applied to the peripheral electrode 40. Specifically, a direct current of 0 V is applied to the first peripheral electrode 40a. In addition, a direct current of −5 V is applied to the second peripheral electrode 40b.

The lamp 1101 or a heater (not shown in the diagram) as a heating unit is turned ON in Step S13. The heater is, for example, provided in the vicinity to in which the liquid crystal panel 100 is arranged. The temperature of the liquid crystal panel 100 is raised by heating of the liquid crystal panel 100. That is, since the temperature of the liquid crystal panel 100 is not immediately warmed, the temperature of the liquid crystal panel 100 is forcibly increased.

Moreover, in a case when the heater is turned ON, the lamp 1101 is turned ON after the heater is turned ON or after fans 1071 to 1074 described later are turned ON and before display.

By increasing the temperature of the liquid crystal panel 100, the mobility of the ionic impurities increases and it is possible to trap the positive (+) ionic impurities which diffuse. In other words, it is possible to increase the collecting efficiency of the ionic impurities.

In Step S14, the cooling fans 1071 to 1074 are turned on. Specifically, at least the fan 1071 cooling the liquid crystal panel 100 and the fan 1073 cooling the lamp 1101 are operated. Moreover, this point becomes the rising period.

In Step S15, display is started. Specifically, display is started by the lamp 1101 becoming somewhat brighter. Moreover, even during display, at least one of the fans 1071 and 1073 for cooling the liquid crystal panel 100 and the lamp 1101 is operated.

In Step S21, display is ended by turning OFF the lamp 1101 (display OFF). From this point the falling period starts. Subsequently, Step S22 or Step S23 is selectively executed.

After Step S22, the cooling strength of the liquid crystal panel 100 is weak compared to the display period. Specifically, the temperature of the liquid crystal panel 100 rapidly lowering may be suppressed, for example, and the cooling strength of the fan 1071 is weakened compared to the display period, or the operation of the fan 1071 stops. A method for weakening the cooling strength of the fan 1071, may be performed by reducing the cooling air flow hitting the liquid crystal panel 100 by, for example, reducing the number of revolutions of the fan 1071.

In so doing, it is possible to lengthen the period that ionic impurities are able to move. As a result, it is possible to increase the effects collecting ionic impurities during the off sequence period.

The liquid crystal panel 100 is heated in Step S23. Specifically, similarly to Step S22, the temperature of the liquid crystal pane 100 is suppressed from rapidly lowering. Examples of the method of heating the liquid crystal panel 100 include, for example, providing a heater at the periphery of the liquid crystal panel 100, or heating with the waste heat of the lamp 1101, or the like. In a case of using the waste heat of the lamp 1101, in Steps S21 to S24, it is preferable that the temperature of the lamp be higher than the temperature of the liquid crystal panel 100.

In so doing, it is possible to lengthen the time from the temperature of the liquid crystal panel 100 during display until cooled to approximately room temperature, and it is possible to lengthen the time that ionic impurities are able to move. As a result, it is possible to suppress the diffusion of ionic impurities in the pixel region E in the off sequence period. Moreover, this point becomes the falling period.

In Step S24, the power source of the projection display device 1000 is turned OFF. Below, mainly in the falling period, the relationship between the temperature of the lamp 1101 and liquid crystal panel 100, and time will be specifically described with reference to FIGS. 9 and 10.

In the graph shown in FIG. 9, the horizontal axis indicates the time of the falling period (off sequence period) from the display period, and times elapses according to movement to the right side of the diagram. On the other hand, the vertical axis indicates the temperature of the lamp 1101 and the liquid crystal panel 100, and the temperature increases upwards from the lower side of the diagram. Moreover, in order that the temperature change of the lamp 1101 and the temperature change of the liquid crystal panel 100 be shown to be easily understood, the upper stage shows the temperature change of the lamp 1101 and the lower stage shows the temperature change of the liquid crystal panel 100.

In addition, in the liquid crystal panel 100, the temperature change of the related are and the temperature change of the embodiment are shown for comparison. Lamps 1071 to 1074 for cooling the respective portions are provided in the vicinity of the lamp 1101 and the liquid crystal panel 100.

Specifically, for the lamp 1101, the fans 1071 to 1074 are used also during lighting and after extinguishing of the lamp 1101. The time until the temperature of the lamp 1101 is lower to a temperature at which it is determined to be necessarily sufficiently cooled after extinguishing from the temperature during lighting (during display period) becomes the falling period (off sequence period) (T0 to T3). After the end of the falling period (T3), the power source of the projection display device 1000 is turned OFF. Moreover, in the lamp 1101, the related art and the embodiment show the same temperature change.

Moreover, lighting of the lamp 1101 is executed in the period from the start of display to the end of display, and periods extinguishing the lamp therein (for example, during intermittent driving) are included in the lighting period.

On the other hand, for the liquid crystal panel 100, similarly to the lamp 1101, the fan 1071 is used during lighting of the lamp 1101 and after extinguishing. The temperature of the liquid crystal panel 100 during display is, for example, approximately 50° C. to 80° C.

For the liquid crystal panel 100 of the related art, the time from ending display (T0) until reaching room temperature (in other words, temperature at which mobility of ionic impurities is sufficiently lowered) is (T1). In the present embodiment, for example, the cooling period of the liquid crystal panel 100 is shorter than the cooling period of the lamp 1101.

In addition, for the liquid crystal panel 100 of the embodiment, the time until the temperature of the liquid crystal panel 100 is maintained so as not to be lowered until room temperature is (T2). The maintenance temperature is, for example, approximately 50° C. to 80° C.

Additionally, the liquid crystal panel 100 is cooled by matching the time until the lamp 1101 is cooled. In so doing, after the end of display, it is possible to inhibit the temperature of the liquid crystal panel 100 from rapidly lowering.

Specifically, after display is ended, the cooling strength of the panel is weakened compared to the related art. In so doing, it is possible to inhibit the temperature of the liquid crystal panel 100 from rapidly lowering compared to the related art. In so doing, it is possible to lengthen the period that ionic impurities are able to move, and it is possible to increase the results of ion trapping in the off sequence period by applying a voltage to the peripheral electrode 40.

Moreover, from the period (T2) after the cooling strength of the panel weakened, the cooling strength of the fan 1071 is increased, and the liquid crystal panel 100 is cooled until (T3). At least, application of a voltage to the peripheral electrode 40 is performed until the temperature of the liquid crystal panel 100 reaches a predetermined temperature (for example, room temperature (30° C. or lower)).

As a result, in the off sequence period, it is possible to maintain the temperature at which the ionic impurities are mobile, and it is possible to increase the results sweeping up the ionic impurities which diffuse. In addition, until the power source of the projection display device 1000 is next turned on, the ionic impurities are gathered at the periphery of the pixel region E. In other word, the movement of the ionic impurities is suppressed by cooling the liquid crystal panel 100 in this state. In so doing, when the power source is on, it is possible to suppress the generation of display unevenness.

For the graph shown in FIG. 10, similarly to the graph shown in FIG. 9, the horizontal axis indicates the time of the falling period (off sequence period) from the display period, and times elapses according to movement to the right side of the diagram. On the other hand, the vertical axis indicates the temperature of the lamp 1101 and the liquid crystal panel 100, and the temperature increases upwards from the lower side of the diagram. Moreover, in order that the temperature change of the lamp 1101 and the temperature change of the liquid crystal panel 100 be shown to be easily understood, the upper stage shows the temperature change of the lamp 1101 and the lower stage shows the temperature change of the liquid crystal panel 100.

In the liquid crystal panel 100, the temperature change of the related art and the temperature change of the embodiment are shown for comparison. Lamps 1071 to 1074 for cooling the respective portions are provided in the vicinity of the lamp 1101 and the liquid crystal panel 100.

Specifically, for the lamp 1101, the fan 1073 is used also during lighting and after extinguishing of the lamp 1101. The time until the temperature of the lamp 1101 is lower to a temperature at which it is determined to be necessarily sufficiently cooled after extinguishing from the temperature during lighting (during display period) becomes the falling period (off sequence period) (T3). After the end of the falling period (T3), the power source of the projection display device 1000 is turned OFF. Moreover, in the lamp 1101, the related art and the embodiment show the same temperature change.

On the other hand, for the liquid crystal panel 100, similarly to the lamp 1101, the fan 1071 is used during lighting of the lamp 1101 and after extinguishing. For the liquid crystal panel 100 of the related art, the time from ending display (T0) until reaching room temperature (in other words, temperature at which mobility of ionic impurities is sufficiently lowered) is (T11). In the present embodiment, for example, the cooling period of the liquid crystal panel 100 is earlier than the cooling period of the lamp 1101.

In addition, for the liquid crystal panel 100 of the embodiment, the time (heating period) until the temperature of the liquid crystal panel 100 is maintained so as not to lower until room temperature is (T12). Additionally, the liquid crystal panel 100 is cooled in the time until the lamp 1101 is cooled. In other words, it is possible to suppress the temperature of the liquid crystal panel 100 suddenly lowering until T12 through cooling the liquid crystal panel 100 by matching the time until the lamp 1101 is cooled.

Specifically, after display is ended, a heater is used to increase the temperature of the liquid crystal panel 100 compared to the related art. In so doing, it is possible to inhibit the temperature of the liquid crystal panel 100 from rapidly lowering compared to the related art. In addition, it is possible to lengthen the movement time of the ionic impurities and, as a result, it is possible to increase the results sweeping up the ionic impurities which diffuse, in the off sequence period.

In addition, by using a heater, the temperature of the liquid crystal panel 100 is able to rise higher than the display period, and it is possible to increase the mobility of the ionic impurities. In addition, since there is concern of ionic impurities being newly generated in heating using light, it is possible to suppress generation of new ionic impurities since heating is by a heater.

Moreover, from the period (T2) after the heater is used, the cooling strength of the fan 1071 is increased, and the liquid crystal panel 100 is cooled to a predetermined temperature until (T3). In this way, as a merit to warming the liquid crystal panel 100 using a heater, for example, there are cases where light strikes the liquid crystal layer 15 and ionic impurities are generated; however, it is possible to prevent such an occurrence.

As described in detail above, according to the projection display device 1000 of the present embodiment, the effects shown below are obtained.

(1) According to the projection display device 1000 of the present embodiment, since it is possible to suppress rapid lowering of the temperature of the liquid crystal panel 100, until the temperature of the lamp 1101 is cooled to a predetermined temperature, by adjusting either one of at least the fan 1071 which is a cooling unit and a heater which is the heating unit, it is possible to suppress rapid lowering of the mobility in the surface of ionic impurities. As a result, in the off sequence period in which the peripheral electrode 40 is used, it is possible to maintain the temperature at which the ionic impurities are mobile, and it is possible to increase the results sweeping up the ionic impurities which diffuse.

(2) According to the projection display device 1000 of the present embodiment, in addition to the off sequence period, by also applying a voltage to the peripheral electrode 40 during the display period, even in a case where ionic impurities are generated by the liquid crystal deteriorating caused by irradiation of light on the liquid crystal layer 15, it is possible for the ionic impurities to collect in the vicinity of the peripheral electrode 40, and possible to inhibit display quality in the display region (pixel region E) from deteriorating.

Moreover, the aspects of the invention are not limited to the above-described embodiments and are able to be appropriately changed within a range not departing from the gist or spirit of the invention read from the claims and the entire specification, and are included in the technical range of the aspects of the invention. In addition, it is possible to execute the embodiments as follows.

### Modification Example 1

As described above, as a method maintaining the liquid crystal panel 100 at a predetermined temperature, the method is not limited to managing time (T0 to T3), and, for example, the method may manage by measuring the temperature of the liquid crystal panel 100. As a method of measuring the temperature (measuring unit), for example, the method may measure the temperature from a voltage (current) generated by causing a thermocouple to contact the liquid crystal panel 100.

As a usage method, for example, the mobility of ionic impurity increases by weakening the cooling strength of the liquid crystal panel 100 from the start of the falling period, and the liquid crystal panel 100 is rapidly cooled by strengthening the cooling strength when the surface temperature of the liquid crystal panel 100 drops below 30° C. (time point T2).

In addition, in a case where a heater is used, for example, the heater is turned ON when the temperature of the liquid crystal panel 100 drops below 30° C., and the heater is turned OFF when the temperature rises above 30° C. In so doing, it is possible to maintain the temperature of the liquid crystal panel 100 at a predetermined temperature for a fixed period.

In this way, by using a measuring unit, such as a thermocouple, it is possible to effectively collect the ionic impurities without being influenced by the usage environment (such as the temperature of the surroundings) of the liquid crystal panel 100.

### Modification Example 2

As described above, the liquid crystal panel 100 may be heated, for example, by a heater while weakening the cooling strength to the liquid crystal panel 100 and is not limited to weakening the cooling strength in the off sequence period (falling period), or heating with a heater.

### Modification Example 3

As described above, one peripheral electrode may be provided, for example, for each of the element substrate 10 side and the counter substrate 20 side, and is not limited to providing a pair of peripheral electrodes 40 (first peripheral electrode 40a, second peripheral electrode 40b) on the element substrate 10 side. Specifically, for example, the second peripheral electrode 40 is provided on the element substrate 10 sides, and the first peripheral electrode 40a is provided on the counter substrate 20 side. The common electrode 31 may be used as the first peripheral electrode 40a. In this case, diffusion of the ionic impurities is prevented between the second peripheral electrode 40b and the common electrode 31 by creating a vertical electrical field.

In addition, the peripheral electrode 40 may be provided on the counter substrate 20 side, and is not limited to the peripheral electrode 40 being provided on the element substrate 10 side. Moreover, if voltage is supplied from the element substrate 10 side, since there is concern of there being no photolithography process or the like on the counter substrate 20 side, and of the associated costs increasing, it is preferable that the peripheral electrode 40 be formed on the element substrate 10 side.

### Modification Example 4

As described above, performing application of the voltage to the peripheral electrode 40 is not limited to until the temperature of the liquid crystal panel 100 being a predetermined temperature (for example, room temperature (30° C. or lower)), or (T2), and may be applied, for example, until T3. According to this, it is possible to increase the effect collecting the ionic impurities during the off sequence.

### Modification Example 5

As described above, cooling may be performed using, for example, a cooling liquid, and is not limited to using the fan 1071 as the method of cooling the liquid crystal panel 100.

### Modification Example 6

As described above, the liquid crystal panel 100 is not limited to the transmissive type, and may be a reflection type. In the case of a reflection type, as the material of the peripheral electrode 40, for example, configuration may be performed using a metallic film having the same reflectivity as the pixel electrode. As the metallic film having reflectivity, for example, aluminum may be used.

### Modification Example 7

As described above, the liquid crystal panel 100 is not limited to use in a projection display device 1000, and, for example, may be used in various electronic devices, such as a heads-up display, smartphone, portable telephone, head-mounted display, EVF (Electrical View Finder), small form factor projector, mobile computer, digital camera, digital video camera, display, vehicle mounted device, audio device, exposure device or illumination device.

This application claims priority from Japanese Patent Application No. 2012-108229 filed in the Japanese Patent Office on May 10, 2012, the entire disclosure of which is hereby incorporated by reference in its entirely.

What is claimed is:

1. A display device comprising:
a liquid crystal panel including a first substrate, a second substrate arranged opposed to the first substrate, a seal material bonding the first substrate and the second substrate, and a liquid crystal layer interposed inside the seal material between the first substrate and the second substrate, and at least one of the first substrate and the second substrate has a peripheral electrode arranged between a seal material and a display region in plan view;
a light source emitting light irradiating the liquid crystal layer in a display period; and
a cooling unit cooling the liquid crystal panel,
wherein a predetermined electric potential is supplied to the peripheral electrode in at least one portion of an off sequence period after the display period, and
the cooling unit lowers the cooling ability of the liquid crystal panel in the off sequence period lower than the cooling ability of the liquid crystal panel in the display period.

2. A display device comprising:
a liquid crystal panel including a first substrate, a second substrate arranged opposed to the first substrate, a seal material bonding the first substrate and second substrate, and a liquid crystal layer interposed inside the seal material between the first substrate and the second substrate, and at least one of the first substrate and the second substrate has a peripheral electrode arranged between a seal material and a display region in plan view;
a light source emitting light irradiating the liquid crystal layer in a display period; and
a heating unit heating the liquid crystal panel,
wherein a predetermined electric potential is supplied to the peripheral electrode in at least one portion of an off sequence period after the display period, and
the heating unit increases the temperature of the liquid crystal panel in the off sequence period higher than the temperature of the liquid crystal panel in the display period.

3. The display device according to claim 2, wherein the heating unit heats the liquid crystal panel so as to be a predetermined temperature during a heating period of the liquid crystal panel.

4. The display device according to claim 1, wherein at least one of either the cooling unit or the heating unit is adjusted such that the temperature of the liquid crystal panel becomes a predetermined temperature in a period until the temperature of the light source is cooled to a predetermined temperature.

5. The display device according to claim 4, wherein a voltage is applied to the peripheral electrode at least from a start of the off sequence period until the temperature of the liquid crystal panel becomes a predetermined temperature.

6. The display device according to claim 1, further comprising a measurement unit measuring the temperature of the liquid crystal panel,
wherein the measurement unit uses a thermocouple.
